(19) United States
(12) Patent Application Publication
(10) Pub. No.: US 2026/0140572 A1
(43) Pub. Date: May 21, 2026

(54) CONTROLLER USE BY HAND-TRACKED COMMUNICATOR AND GESTURE PREDICTOR

(71) Applicant: Sony Interactive Entertainment Inc., Tokyo (JP)

(72) Inventors: Glenn Black, San Mateo, CA (US); Victoria Dorn, San Mateo, CA (US); Andrew Young, San Mateo, CA (US)

(21) Appl. No.: 19/451,816

(22) Filed: Jan. 16, 2026

Related U.S. Application Data
(63) Continuation of application No. 18/352,611, filed on Jul. 14, 2023.

(51) Int. Cl. G06F 3/01; A63F 13/428; G06N 20/00; G06V 10/70; G06V 40/20

(52) U.S. Cl. CPC G06F 3/017; A63F 13/428; G06N 20/00; G06V 10/70; G06V 40/28

(57) ABSTRACT

A method including capturing a deformed gesture performed by a communicator, wherein the deformed gesture corresponds to a defined gesture that is intended by the communicator. The method including providing the deformed gesture that is captured to an artificial intelligence (AI) model configured to classify a predicted gesture corresponding to deformed gesture. The method including performing an action based on the predicted gesture. The method including capturing at least one multimodal cue to verify the predicted gesture. The method including determining that the predicted gesture is incorrect based on the at least one multimodal cue. The method including providing feedback to the AI model indicating that the predicted gesture is incorrect for training and updating the AI model. The method including classifying an updated predicted gesture corresponding to the deformed gesture using the AI model that is updated.

### CROSS-REFERENCE TO RELATED APPLICATION

The application is a continuation and claims the benefit of priority of U.S. application Ser. No. 18/352,611, filed Jul. 14, 2023, the entire contents of which are hereby incorporated by reference in its entirety.

### TECHNICAL FIELD

The present disclosure is related to communication using gestures, and more specifically to identify a deformed or occluded gesture through tracking motion of a hand held controller or a portion of a communicator, and matching the performed gesture to a defined gesture using artificial intelligence.

### BACKGROUND OF THE DISCLOSURE

Communication can be conveyed using gestures of a communicator. The gesture may be performed by any portion of a body of a human, such as the hand, or finger, or mouth, etc., or any other communicator device, such as a controller. By tracking motion of the portion of the human or the communicator device, a corresponding gesture may be determined.

However, there are situations where a gesture cannot properly be identified. For example, when the communicator is within a confined space, the area within which the communicator performs gestures may be constrained, such that a performed gesture is not fully performed. In other examples, the performed gesture may be partially occluded, such as by an intervening obstruction. In those situations, a corresponding gesture that is performed but mis-shaped may not be recognized and/or identified.

Continued misidentification of the gesture now or in the future is frustrating for the communicator. Even repeated performances of the gesture may not remedy the problem (e.g., confined space), which leads to continued misidentification of the gesture. Ultimately, the experience of the communicator will suffer.

It is in this context that embodiments of the disclosure arise.

### SUMMARY

Embodiments of the present disclosure relate to the identification of a gesture that is occluded or deformed when performed by a communicator, wherein the gesture is identified using machine learning model trained to identify the intent of the gesture.

In one embodiment, a method is disclosed. The method including capturing a deformed gesture performed by a communicator, wherein the deformed gesture corresponds to a defined gesture that is intended by the communicator. The method including providing the deformed gesture that is captured to an artificial intelligence (AI) model configured to classify a predicted gesture corresponding to deformed gesture. The method including performing an action based on the predicted gesture. The method including capturing at least one multimodal cue to verify the predicted gesture. The method including determining that the predicted gesture is incorrect based on the at least one multimodal cue that is captured. The method including providing feedback to the AI model indicating that the predicted gesture is incorrect for training the AI model, wherein the AI model is updated based on the feedback. The method including classifying an updated predicted gesture corresponding to the deformed gesture using the AI model that is updated.

In another embodiment, a non-transitory computer-readable medium storing a computer program for implementing a method is disclosed. The computer-readable medium including program instructions for capturing a deformed gesture performed by a communicator, wherein the deformed gesture corresponds to a defined gesture that is intended by the communicator. The computer-readable medium including program instructions for providing the deformed gesture that is captured to an AI model configured to classify a predicted gesture corresponding to deformed gesture. The computer-readable medium including program instructions for performing an action based on the predicted gesture. The computer-readable medium including program instructions for capturing at least one multimodal cue to verify the predicted gesture. The method including determining that the predicted gesture is incorrect based on the at least one multimodal cue that is captured. The computer-readable medium including program instructions for providing feedback to the AI model indicating that the predicted gesture is incorrect for training the AI model, wherein the AI model is updated based on the feedback. The computer-readable medium including program instructions for classifying an updated predicted gesture corresponding to the deformed gesture using the AI model that is updated.

In still another embodiment, a computer system is disclosed, wherein the computer system includes a processor and memory coupled to the processor and having stored therein instructions that, if executed by the computer system, cause the computer system to execute a method. The method including capturing a deformed gesture performed by a communicator, wherein the deformed gesture corresponds to a defined gesture that is intended by the communicator. The method including providing the deformed gesture that is captured to an AI model configured to classify a predicted gesture corresponding to deformed gesture. The method including performing an action based on the predicted gesture. The method including capturing at least one multimodal cue to verify the predicted gesture. The method including determining that the predicted gesture is incorrect based on the at least one multimodal cue that is captured. The method including providing feedback to the AI model indicating that the predicted gesture is incorrect for training the AI model, wherein the AI model is updated based on the feedback. The method including classifying an updated predicted gesture corresponding to the deformed gesture using the AI model that is updated.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1 illustrates a system including an gesture prediction engine configured for prediction of a deformed gesture performed by a communicator using an artificial intelligence (AI) model, and training the AI model with feedback data used to determine that the predicted gesture is incorrect, in accordance with one embodiment of the present disclosure, in accordance with one embodiment of the present disclosure.

FIG. 2 is a flow diagram illustrating a method for predicting a deformed gesture performed by a communicator using an AI model, and determining that the predicted gesture is incorrect based on multimodal cues for purposes of updating the AI model, in accordance with one embodiment of the present disclosure.

FIG. 3 is an illustration of a system configured to implement an artificial intelligence model configured for predicting a deformed gesture performed by a communicator using an AI model, and providing feedback for updating the AI when the prediction of the deformed gesture is incorrect, in accordance with one embodiment of the present disclosure.

FIG. 4 is an illustration of a gesture prediction engine configured to predict a deformed gesture performed by a communicator using an AI model, and determine that the prediction is incorrect, which can be fed back to the AI model for updating, in accordance with one embodiment of the present disclosure.

FIGS. 5A-5C illustrate a deformed gesture performed by a communicator, the reshaping of a deformed gesture that is performed within a gesture space that is physically or virtually constrained by removing an effect of the corresponding constraint, and reshaping of a gesture space defined for a fully performed gesture in consideration of the constraint, in accordance with embodiments of the present disclosure.

FIG. 6 is a flow diagram illustrating a method for early prediction of a gesture, in accordance with one embodiment of the present disclosure.

FIG. 7 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure are set forth without any loss of generality to, and without imposing limitations upon, the claims that follow this description.

Generally speaking, the various embodiments of the present disclosure describe systems and methods for correctly identifying gestures that may be occluded or deformed, and the dynamic updating of an AI model used for predicting the gesture when the prediction is incorrect. The gestures may be performed by a communicator to convey communication in some language (e.g., sign language, gaming language, etc.) with another person or to an application (e.g., metaverse or video game, etc.). The gesture may be performed when communicating (e.g., when communicating with another using sign language), and/or when participating in a virtual world (e.g., a metaverse viewed through a head mounted display - HMD), and/or when playing a video game. For example, the communicator may be performing movements of a hand or portion of the body to perform the gesture. Also, during when in a metaverse or during gameplay of a video game, the communicator may be holding a single controller or a pair of controllers, such as those that are used within a virtual reality (VR) mode. In some cases, the communicator's hands may be partially or completely occluded or constrained when performing the gesture, such that the gesture may be deformed. In one embodiment, machine learning and/or AI can be implemented to identify specific hand gestures performed by a communicator, including when holding a controller, and even when the gesture is deformed or occluded. Machine learning can identify when specific motions by fingers and/or hands are made, as well as when facial expressions are made, and determine their intended meanings. The intended meaning can also be further identified with confidence using game context. For example, if the communicator through a first avatar is directing a second avatar of another player toward a river that requires the second avatar to jump over steppingstones, the communicator can make gestures that appear to be “jump over the river.” For instance, the players may be on a team working cooperatively to accomplish a task. Although the communicator cannot make the full gesture to communicate jump over the river, the context of the game and the partial hand gestures and movements can be interpreted to predict the intent of the communicator is to say jump over the river. In one embodiment, an AI model can be trained to identify the intent. For example, the communicator can say “when I do this” I mean “this.” The AI model can also be used to ask the communicator if the meaning of the gestures correct, (e.g., “did you mean to say jump?”) when verifying the predicted interpretation of the deformed gesture, with results fed back to the AI model for updating. This type of reinforced learning can be useful to quickly adapt to the type of gestures performed by different communicators, such as when one or both hands are holding a controller, when each communicator may perform a particular gesture in slightly different ways.

Advantages of the methods and systems configured to identify gestures that may be occluded or deformed by a communicator using an AI model include the dynamic updating of the AI model with feedback when the prediction of the gesture is incorrect. In that manner, the AI model is adaptable to the movements of the communicator and/or to the environment (e.g., real or virtual) within which the communicator is performing the gesture. Still another advantage includes the quick re-prediction of the gesture that may be deformed or occluded using the AI model that is updated using feedback from the earlier mis-prediction. Still another advantage includes improved user experience, as the communicator is not left frustrated or exasperated with the same mis-prediction of the gesture that is deformed or occluded, because the AI model is dynamically updated with real-time feedback such that the gesture ultimately is predicted with satisfaction by the communicator.

Throughout the specification, the reference to “game” or video game” or “gaming application” is meant to represent any type of interactive application that is directed through execution of input commands. For illustration purposes only, an interactive application includes applications for gaming, word processing, video processing, video game processing, etc. Also, the terms “virtual world” or “virtual environment” or “metaverse” is meant to represent any type of environment generated by a corresponding application or applications for interaction between a plurality of users in a multi-player session or multi-player gaming session. Further, the terms introduced above are interchangeable.

In addition, embodiments of the present disclosure can be used within any context for purposes of providing communication. For example, gesture prediction may be used when a communicator is communicating with another using sign language, or when the communicator is communicating with another in the metaverse or a gaming environment, or when the communicator is providing gaming commands when playing a video game. For purposes of illustration only, embodiments of the present disclosure may be described within the context of a game play of a player playing a video game, but is understood to represent any communication within any environment, such as when performing sign language, or communicating with another in the metaverse or gaming environment, or when gaming.

With the above general understanding of the various embodiments, example details of the embodiments will now be described with reference to the various drawings.

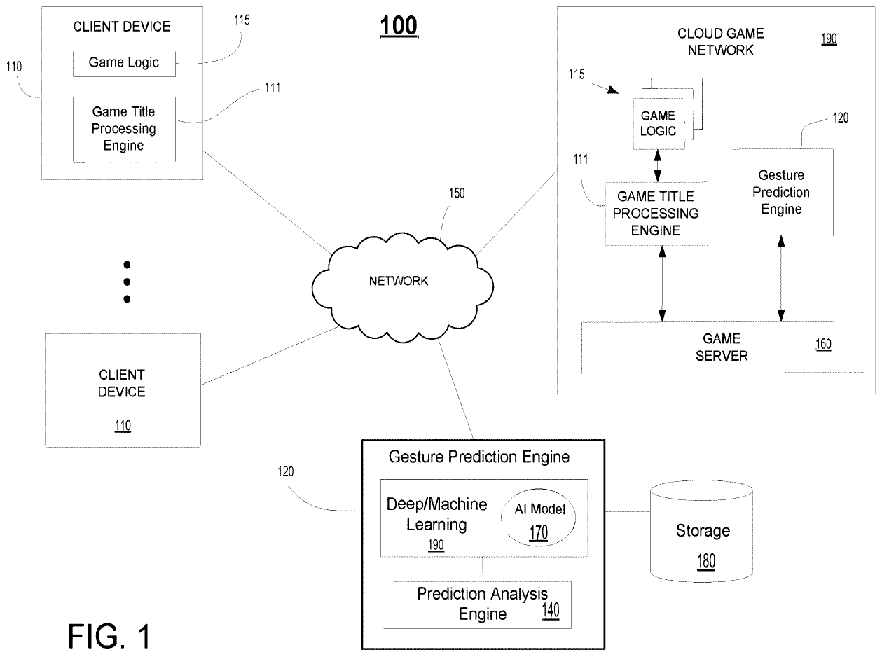

FIG. 1 illustrates a system 100 including a gesture prediction engine 120 including an AI model 170 that provides for identification of gestures performed by a communicator that may be deformed or occluded, and the dynamic updating of the AI model with feedback when the prediction of the gesture is incorrect. In that manner, the AI model is continually updated to adapt to the uniquely personal movements of the communicator, and also to adapt to the environment (e.g., real or virtual) within which the communicator is performing the gesture.

As shown, system 100 may provide gaming over a network 150 for one or more client devices 110. In particular, system 100 may be configured to provide gaming to users participating in a single-player or multi-player gaming sessions (e.g., participating in a video game in single-player or multi-player mode, participating in a metaverse generated by an application with other players, etc.) via a cloud game network 190, wherein the game can be executed locally (e.g., on a local client device of a corresponding user) or can be executed remotely from a corresponding client device 110 (e.g., acting as a thin client) of a corresponding user that is playing the video game, in accordance with one embodiment of the present disclosure. In at least one capacity, the cloud game network 190 supports a multi-player gaming session for a group of users, to include delivering and receiving game data of players for purposes of coordinating and/or aligning objects and actions of players within a scene of a gaming world or metaverse, managing communications between user, etc. so that the users in distributed locations participating in a multi-player gaming session can interact with each other in the gaming world or metaverse in real-time. In another capacity, the cloud game network 190 supports multiple users participating in a metaverse.

In one embodiment, the cloud game network 190 may support artificial intelligence (AI) based services including chatbot services (e.g., ChatGPT, etc.) that provide for one or more features, such as conversational communications, composition of written materiel, composition of music, answering questions, simulating a chat room, playing games, and others.

Users access the remote services with client devices 110, which include at least a CPU, a display and input/output (I/O). For example, users may access cloud game network 190 via communications network 150 using corresponding client devices 110 configured for providing input control, updating a session controller (e.g., delivering and/or receiving user game state data), receiving streaming media, etc. The client device 110 can be a personal computer (PC), a mobile phone, a personal digital assistant (PAD), handheld device, etc.

In one embodiment, as previously introduced, client device 110 may be configured with a game title processing engine and game logic 115 (e.g., executable code) for at least some local processing of an application, and may be further utilized for receiving streaming content as generated by the application executing at a server, or for other content provided by back-end server support.

In another embodiment, client device 110 may be configured as a thin client providing interfacing with a back end server (e.g., game server 160 of cloud game network 190) configured for providing computational functionality (e.g., including game title processing engine 111 executing game logic 115—i.e., executable code—implementing a corresponding application). In particular, client device 110 of a corresponding user is configured for requesting access to applications over a communications network 150, such as the internet, and for rendering for display images generated by a video game executed by the game server 160, wherein encoded images are delivered (i.e., streamed) to the client device 110 for display. For example, the user may be interacting through client device 110 with an instance of an application executing on a game processor of game server 160 using input commands to drive a gameplay. Client device 110 may receive input from various types of input devices, such as game controllers, tablet computers, keyboards, gestures captured by video cameras, mice, touch pads, audio input, etc.

In addition, system 100 includes a gesture prediction engine 120 configured to predict and/or identify gestures that may be deformed or occluded when performed using an AI model. The gesture prediction engine 120 may be implemented at the back-end cloud game network, or as a middle layer third party service that is remote from the client device. In some implementations, the gesture prediction engine 120 may be located at a client device 110. The prediction of the gesture may be performed using artificial intelligence (AI) via an AI layer. For example, the AI layer may be implemented via an AI model 170 as executed by a deep/machine learning engine 190 of the gesture prediction engine 120. An action may be performed based on the predicted gesture, such as translating and providing communication to another related to the predicted gesture (i.e., within or external to a metaverse or video game), or providing an instruction or command to an executing video game.

The gesture prediction engine includes a prediction analysis engine 140 that is also configured to determine when the prediction of the gesture is incorrect based on one or more multimodal cues of the communicator and/or the gaming environment, wherein feedback when the prediction is correct and/or incorrect is used to update and/or train the AI model to continually adapt to the movements of the communicator and/or the environment within which the communicator is performing the gesture. Storage 180 may be used for storing information, such as information related to the feedback and/or data used for building the AI model 170.

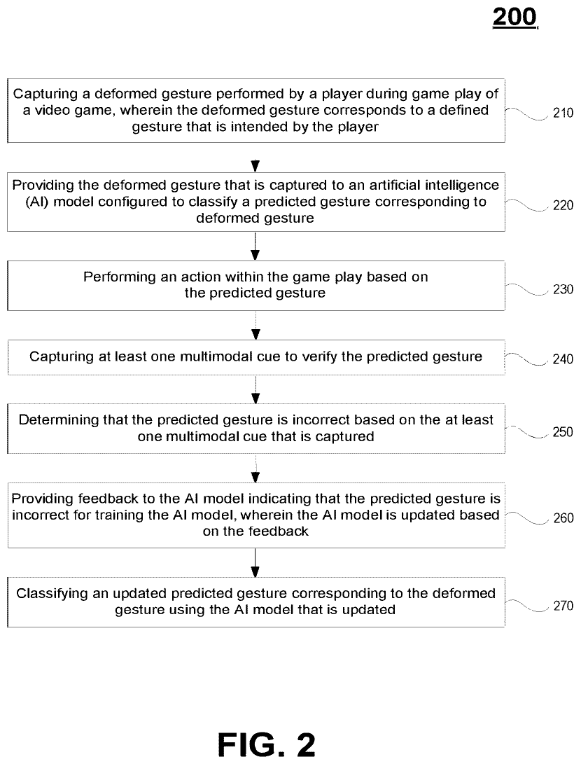

With the detailed description of the system 100 of FIG. 1, flow diagram 200 of FIG. 2 discloses a method for predicting a deformed gesture performed by a communicator using an AI model, and determining that the predicted gesture is incorrect based on multimodal cues for purposes of updating the AI model, in accordance with one embodiment of the present disclosure. The operations performed in the flow diagram may be implemented by one or more of the entities previously described components, and also system 100 described in FIG. 1, including gesture prediction engine 120.

At 210, the method includes capturing a deformed gesture performed by a communicator, wherein the deformed gesture corresponds to a defined gesture that is intended by the communicator. The performed gesture is determined from tracking a portion of the communicator (e.g., hand, finger, face, etc.), or movement of a controller (e.g., hand-held controller). The deformed gesture may result from one of many factors, including for example, impatience or urgency of the communicator, or a confined area to perform the gesture. In addition, the deformed gesture may result from an occlusion that is blocking tracking.

For purposes of illustration, the gesture may be performed to convey communication between two persons using sign language, or a communication with another in a metaverse, or communication with another in a game play of a video game. Also the gesture may be performed by a player during game play of a video game, such as when the gesture indicates a command or instruction provided to an executing gaming application.

At 220, the method includes providing the deformed gesture that is captured to an artificial intelligence (AI) model to determine a predicted gesture. In particular, the AI model is configured to classify the predicted gesture. For instance, the deformed gesture is matched to one of a plurality of defined gestures known to the AI model.

At 230, the method includes performing an action based on the predicted gesture. For example, within the context of relaying communication, as an action the predicted gesture may be translated to text and delivered to a receiving party, or translated to a motion given to an avatar of the communicator. Within the context of the metaverse or gaming, the predicted gesture may be translated to a motion for an avatar representing the communicator and delivered to a receiving party. Within the context of gaming, the predicted gesture may be translated to a command, which can be executed by a video game for a game play.

At 240, the method includes capturing at least one multimodal cue to verify the predicted gesture. For example, the multimodal cues may track one or more characteristics of the communicator (e.g., motions, biometrics, etc.), game state of a game play, environment of the communicator (e.g., spatial relations of objects, audio, mapping, etc.), and other data. The multimodal cues may be received from a plurality of tracking devices configured to track the communicator/player and/or the environment surrounding the communicator. Specifically, captured information is analyzed, in part, by each of a plurality of trackers, wherein each tracker is customized to determine at least one multi-modal cue or factor used for verifying the predicted gesture. For instance, the trackers may track a certain behavior (e.g., satisfied, unsatisfied, frustrated, happy, angry) of the communicator, or be used for mapping the environment of the communicator (e.g., determine obstructions within a gesture space), etc.

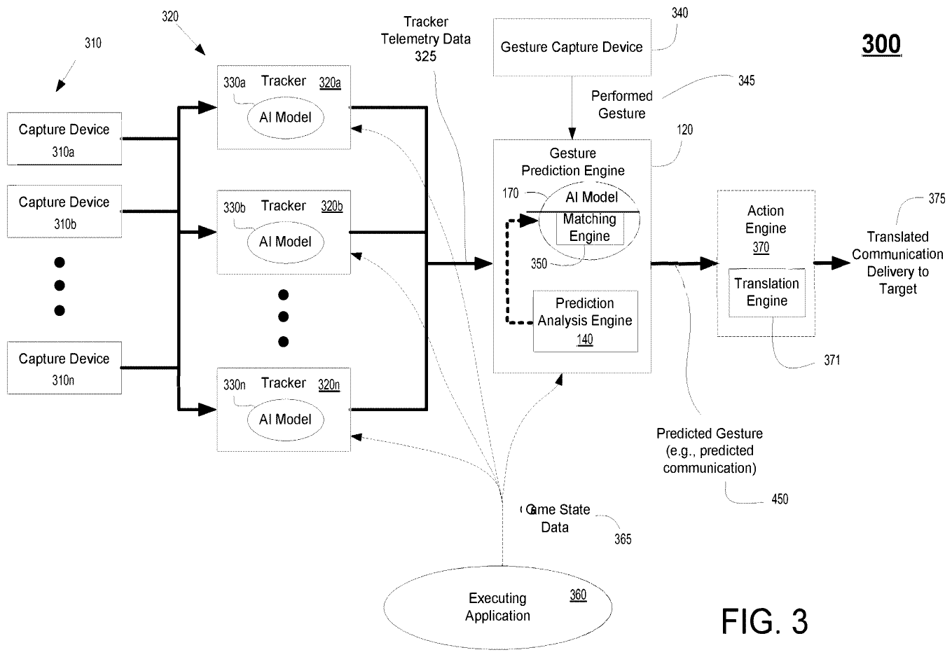

At 250, the method includes determining that the predicted gesture is incorrect based on the at least one multimodal cue that is captured and/or determined by corresponding trackers. In particular, analysis is performed on at least one multimodal cue. The greater the number of multimodal cues used for analysis may provide for a more accurate determination on whether the predicted gesture is correct or incorrect. Each of the multimodal cues may be provided through AI analysis by a corresponding tracker (e.g., 320a . . . n), as will be described in FIG. 3. For example, the analysis performed on the at least one multimodal cue may determine that predicted gesture is incorrect through indirect inference, or through direct querying of the communicator.

An indirect inference may be reached that the predicted gesture is incorrect through analysis by determining that the player is unsatisfied or frustrated or angry or unhappy with the action that is performed within the game play based on the at least one multimodal cue. For example, the analysis may pick up on biometrics (increased heart rate, facial expression of dissatisfaction, etc.) or actions by the communicator (e.g., reattempting the gesture and possibly with greater intensity or speed, an utterance of exasperation), etc. If the communicator behaves normally, then most probably the predicted gesture is correct.

In still another embodiment, an indirect inference may be reached by determining a game context of the game play based on game state that is captured as a cue. For instance, the game state may be used to determine a game context of the game play. The predicted gesture is inferred to be incorrect when the predicted gesture is not consistent with the game context.

On the other hand, a direct query on whether the predicted gesture and/or resulting action was correct may be made to the communicator. This may be made to accurately determine that the predicted gesture is incorrect, especially if the AI model is in its infancy when learning to adapt to the communicator. Normally, direct queries are used with caution in order to minimize interruptions with the communicator. However, direct queries can be used to quickly train the AI model, such that as the AI model continually gets updated, a direct query may not need to be made for similar queries, that may be deformed, that are performed as the AI model has learned which predicted gestures corresponding to defined gestures to avoid, and which remain for matching.

At 260, the method includes providing feedback to the AI model indicating that the predicted gesture is incorrect for training the AI model. In that manner, the predicted gesture that is incorrect is removed from a solve set of defined gestures for the deformed gesture to update the AI model. With continued feedback and updating of the AI model, gradually the solve set of defined gestures for this particular deformed gesture is reduced so that a predicted gesture in the future more accurately matches the intended, defined gesture.

At 270, the method includes using the updated AI model to reclassify the deformed gesture. This can be performed without having the communicator reattempt the gesture, which minimizes interruptions to the communicator. In particular, the deformed gesture is reclassified as an updated predicted gesture using the AI model that is updated.

In one embodiment, the AI model is updated by reshaping the deformed gesture or the gesture space that is deformed. In particular, a filter or condition may be applied based on analysis of one or more multimodal cues. A physical or virtual constraint may impede full performance of the gesture that is deformed, wherein the constraint may be discovered through mapping. Once the AI model learns the constraint, the gesture space that is constrained may be reshaped, and correspondingly the deformed gesture can be reshaped similarly with the reshaping of the gesture space that is constrained. The reshaped deformed gesture matches the defined gesture when reclassifying the deformed gesture. In another embodiment, the full gesture space is reshaped based on the constraint, such that the defined gesture can be reshaped similarly with the reshaping of the full gesture space. In that manner, the deformed gesture matched the defined gesture that is reshaped when reclassifying the deformed gesture.

FIG. 3 is an illustration of a system 300 configured to implement an artificial intelligence model configured for predicting a deformed gesture performed by a communicator using an AI model, and providing feedback for updating the AI when the prediction of the deformed gesture is incorrect, in accordance with one embodiment of the present disclosure. Although system 300 is described within the context of two persons communicating with each other, including a first or gesturing communicator that is communicating some form of communication (e.g., a gesture), and a second or receiving communicator that receives the communication, it is understood that system 300 can be implemented within any context of communication, including when communicating (e.g., when communicating with another using sign language), and/or when communicating with another in a virtual world (e.g., a metaverse viewed through a head mounted display—HMD), and/or communicating with another player when playing a video game, and/or providing instructions to a video game for execution. The operations performed in the flow diagram may be implemented by one or more of the entities previously described components, and also system 100 described in FIG. 1. For purposes of illustration, FIG. 3 is described within the context of a third party or mid-level gesture prediction engine communicatively coupled through a network, although it is understood that the operations performed within system of FIG. 3 can be performed by the cloud based network 190 or the client device 110 of FIG. 1.

A plurality of capture devices 310, including capture devices 310a through 310n, is shown within the surrounding environment of a communicator. Each of the capture devices is configured to capture data and/or information related to the communicator or the surrounding environment. For example, a capture device may capture biometric data of the communicator, and include cameras pointed at the communicator, biometric sensors, microphone, hand movement sensors, finger movement sensors, etc. Purely for illustration purposes, biometric data captured by the capture devices 310 may include heart rate, facial expressions, eye movement, intensity of input provided by the player, speed of audio communication, audio of communication, intensity of audio communication, etc. In addition, capture devices may capture other related information, including information about the environment within which the communicator is communicating or performing gestures. For example, capture devices may include cameras and/or ultra-sonic sensors for sensing the environment, cameras and/or gyroscopes for sensing controller movement, microphones for detecting audio from the communicator or devices used by the communicator,

The information captured by the plurality of capture devices 310 is sent to one or more of the plurality of trackers 320 (e.g., trackers 320a-n). Each of the plurality of trackers includes a corresponding AI model configured for performing a customized classification of data, which is then output as telemetry data 325 and received by the gesture prediction engine 120. The telemetry data may be considered as multimodal cues, wherein each tracker provides a unique multimodal cue, and wherein one or more multimodal cues may be used to determine whether a gesture performed by the communicator has been correctly predicted.

For example, tracker 320a includes AI model 330a, tracker 320b includes AI model 330b . . . and tracker 320 n includes AI model 330n. In particular, each of the trackers collects data from one or more capture devices 310, and is configured to perform a customized function. For example, a customized function may be to determine in which direction the eyes of the communicator are pointed, and may collect data from one or more capture devices, including eye tracking cameras, head motion trackers, etc. The customized AI model is configured to analyze the data and determine gaze direction. Another customized function may be to determine when the communicator has a particular emotion (e.g., happy, angry, satisfied, unsatisfied, frustrated, etc.), and may collect data from one or more capture devices, including facial cameras to perform tracking of portions of the face (e.g., to determine facial expressions); biometric sensors to capture heart rate, facial expressions, eye movement, rate of sweating, rate of breathing, etc. ; movement sensors to capture hand or finger movement and intensity or speed of the movement, controller movement, etc. ; audio receivers to capture audio uttered from the communicator (e.g., intensity, speed, etc.), or generated by the communicator (e.g., keyboard usage intensity, intensity of input provided by the communicator), or of the surrounding environment, etc. The customized AI model is configured to analyze the captured data and determine an emotion of the communicator (e.g., determine communicator is frustrated thereby inferring that a predicted gesture is incorrect). Another customized function may be to determine obstacles within an environment surrounding the communicator, and may collect data from one or more capture devices, including mapping cameras, depth sensors to determine depth of objects, ultra-sonic sensors, etc. The customized AI model is configured to analyze the data and determine if an obstacle is blocking movement of the communicator (e.g., blocking the communicator from performing a gesture within a gesture space).

Further, the gesture prediction engine 120, configured to identify gestures that may be occluded or deformed by a communicator, may receive game state 365 that is generated from an executing application (e.g., video game, gaming application, metaverse application, etc.). For example, the game state may be from a game play of a video game, or a state of an application during execution. Regarding a video game, game state data defines the state of the game play of an executing video game for a player at a particular point in time. Game state data allows for the generation of the gaming environment at the corresponding point in the game play. For example, game state data may include states of devices used for rending the game play (e.g., states of the CPU, GPU, memory, register values, etc.), identification of the executable code to execute the video game at that point, game characters, game objects, object and/or game attributes, graphic overlays, and other information. The game state may be used for predicting the gesture performed by the communicator and/or to verify that a predicted gesture is correct, by determining game context based on the game state and determining whether the corresponding predicted gesture is consistent with the game context. In one embodiment, the game state may be included as one of the multimodal cues used for determining whether a predicted gesture is correct.

Further, other information may be captured, including user saved data used to personalize a video game for the corresponding player (e.g., character information and/or attributes used to generate a personalized character, user profile data, etc.), and metadata configured to provide relational information and/or context for other information, such as the game state data and the user saved data. For example, the metadata may include information describing the gaming context of a particular point in the game play of a player, such as where in the game the player is, type of game, mood of the game, rating of game (e.g., maturity level), the number of other players there are in the gaming environment, game dimension displayed, which players are playing a particular gaming session, descriptive information, game title, game title version, franchise, format of game title distribution, downloadable content accessed, links, credits, achievements, awards, trophies, and other information.

A gesture capture device 340 is configured to capture a gesture performed by a communicator, and output a performed gesture 345, including information represented of the performed gesture. For example, the capture device 340 may be camera, or a motion capture device that is configured to determine and/or capture one or more patterns of motion of the communicator, wherein each of the patterns may correspond to a portion of the gesture. The performed gesture 345 is associated with an intended meaning by the communicator.

The gesture prediction engine 120 receives the performed gesture 345, and is configured to classify the performed gesture 345 as a predicted gesture 450 using the AI model 170. In one embodiment, the AI model includes a matching engine 350 configured to match the performed gesture 345 to a predefined gesture (i.e., with a defined pattern of motion for the gesture and a defined interpretation for the defined pattern) that is known to the system 300. As such, the AI model 170, that may also perform matching, classifies the performed gesture 345 as a predicted gesture 450 (i.e., the matched predefined gesture).

The predicted gesture 450 is delivered to an action engine 370 that performs an action based on the predicted gesture. That is, the action is performed based on a defined meaning of the predicted gesture. In one implementation, for communication between players (e.g., in a video game or metaverse), a translation engine 371 is configured to translate the predicted gesture into a translated communication 375 that is delivered to a target. For example, the action performed may be having an avatar of the communicator perform the predicted gesture, such as when the communicator is motioning the target to look in a certain direction in the environment. In another implementation, the action may include translating the predicted gesture into a text audio message for delivery to the target within an environment. In another implementation, the action may be to execute a certain instruction when executing a video game, such as when the communicator is playing a video game using gestures as gaming input. Still other actions to be performed based on the predicted gesture are supported.

Further, the gesture prediction engine 120 includes a prediction analysis engine 140 configured to provide feedback on the predicted gesture 450, wherein the feedback is provided based on information collected post-performance of the action. In particular, the prediction analysis engine 140 analyzes multimodal cues collected from the plurality of trackers 320 and the game state data to determine whether the predicted gesture 450 is correct. For example, the prediction analysis engine 140 may determine that the communicator is frustrated immediately after an action is performed based on a predicted gesture, and infer that the predicted gesture 450 is incorrect. Feedback indicating that the predicted gesture is incorrect may be provided to the AI model 170 for training. An updated predicted gesture using the updated AI model 170 may be output by the gesture prediction engine based on the originally performed gesture 345, whereupon another action is then performed based on the updated predicted gesture.

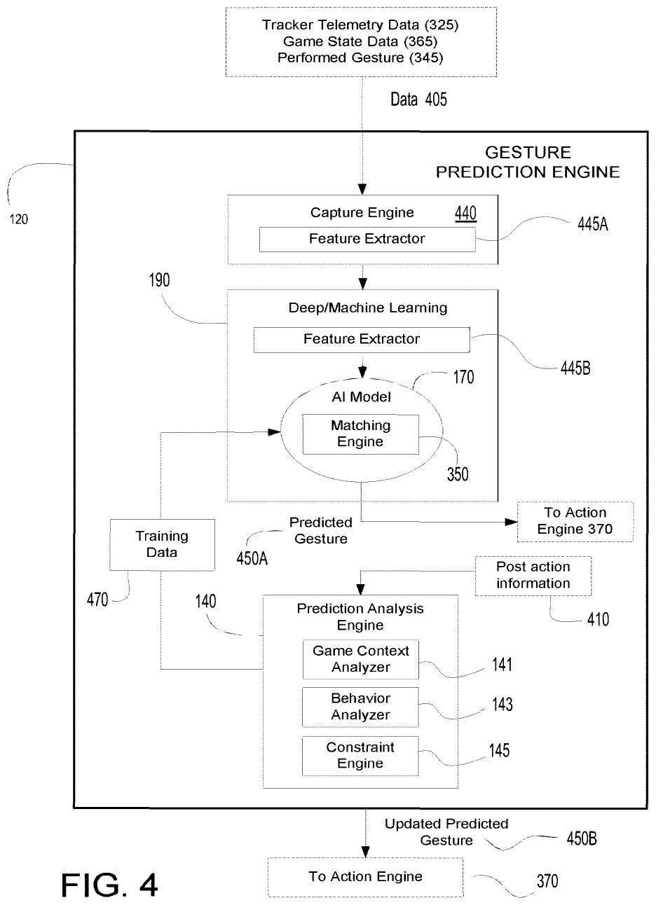

FIG. 4 is an illustration of a gesture prediction engine 120 configured to implement an artificial intelligence (AI) model 170 to predict the intent of a deformed gesture that is performed by a communicator, in accordance with one embodiment of the present disclosure. More specifically, the gesture prediction engine 120 is configured to determine that the prediction is incorrect, and provide feedback indicating the prediction is incorrect (or correct) to the AI model for updating, in accordance with one embodiment of the present disclosure.

Capture engine 440 of the gesture prediction engine 120 may be configured to receive various data 405 through a network relevant to predicting an intent of a performed gesture, and to verify that the prediction is correct. As previously described, the received data 405 may include telemetry data 325 from the plurality of trackers 320, state data and/or game state data 365 from an executing application (e.g., video game, metaverse, etc.), user saved data, metadata, and/or information related to the performed gesture 345.

The capture engine 440 is configured to provide input into the AI model 170 for classification of information (e.g., patterns of motion) associated with a performed gesture that may be deformed. As such, the capture engine 340 is configured to capture and/or receive as input any data that may be used to identify and/or classify a performed gesture (i.e., predicted gesture), and/or to verify that the predicted gesture is correct. Selected portions of the captured data may be analyzed to identify and/or classify the gesture. In particular, the received data 405 is analyzed by feature extractor 445A to extract out the salient and/or relevant features useful in classifying and/or identifying gestures performed by the communicator. The feature extractor may be configured to learn and/or define features that are associated with defined gestures that are known, or portions thereof. In some implementations, feature definition and extraction is performed by the deep/machine learning engine 190, such that feature learning and extraction is performed internally, such as within the feature extractor 445B.

As shown, the deep/machine learning engine 190 is configured for implementation to classify and/or identify and/or predict a performed gesture of a communicator (i.e., corresponding to a predicted intent of the communicator). In one embodiment, the AI model 170 is a machine learning model configured to apply machine learning to classify/identify/predict the performed gesture and/or the intent of the performed gesture. In another embodiment, the AI model is a deep learning model configured to apply deep learning to classify/identify/predict the performed gesture, wherein machine learning is a sub-class of artificial intelligence, and deep learning is a sub-class of machine learning.

Purely for illustration, the deep/machine learning engine 190 may be configured as a neural network used to implement the AI model 170, in accordance with one embodiment of the disclosure. Generally, the neural network represents a network of interconnected nodes responding to input (e.g., extracted features) and generating an output (e.g., classify or identify or predict the intent of the performed gesture). In one implementation, the AI neural network includes a hierarchy of nodes. For example, there may be an input layer of nodes, an output layer of nodes, and intermediate or hidden layers of nodes. Input nodes are interconnected to hidden nodes in the hidden layers, and hidden nodes are interconnected to output nodes. Interconnections between nodes may have numerical weights that may be used link multiple nodes together between an input and output, such as when defining rules of the AI model 170.

In particular, the AI model 170 is configured to apply rules defining relationships between features and outputs (e.g., events occurring within game plays of video games, etc.), wherein features may be defined within one or more nodes that are located at one or more hierarchical levels of the AI model 170. The rules link features (as defined by the nodes) between the layers of the hierarchy, such that a given input set of data leads to a particular output (e.g., event classification 350) of the AI model 170. For example, a rule may link (e.g., using relationship parameters including weights) one or more features or nodes throughout the AI model 170 (e.g., in the hierarchical levels) between an input and an output, such that one or more features make a rule that is learned through training of the AI model 170. That is, each feature may be linked with one or more features at other layers, wherein one or more relationship parameters (e.g., weights) define interconnections between features at other layers of the AI model 170. As such, each rule or set of rules corresponds to a classified output. In one implementation, the AI model 170 includes a matching engine 350. In particular, matching engine 350 configured to match the performed gesture including deformities to a defined gesture that is known, wherein the matching of the deformed gesture implements AI techniques. In that manner, the resulting output according to the rules of the AI model 170, which may or may not include the matching engine, may classify and/or label and/or identify and/or predict a performed gesture, and more specifically the intent of the performed gesture, wherein the output is the predicted gesture 450A.

Further, the output (e.g., predicted gesture 450A) from the AI model 170 may be used to determine a course of action to be taken for the given set of input (e.g., extracted features), as performed by the different services provided by the action engine 370 based on the predicted gesture, as previously introduced. For example, for communication the action engine may translate the predicted gesture into a format for delivery to a target, including performing a defined gesture by an avatar (e.g., that corresponds to the predicted gesture and/or intent of the communicator as when performing sign language); sending text as a translated message, sending audio as a translated message, etc. In another embodiment, the action may include execution of input or a command for an application or video game. Still other actions to be performed based on the predicted gesture are supported.

As shown, the gesture prediction engine 120 is also configured to perform verification of the predicted gesture 450A. In particular, after the action is performed by the action engine 370 responsive to the predicted gesture 450A, additional data is collected and delivered to the prediction analysis engine 140 to determine whether the predicted gesture 450 is correct. The additional data may include data 405 that is updated, including telemetry data 325 from the plurality of trackers 320, game state data 365, metadata, etc.

In particular, the gesture prediction engine 120 may include a game context analyzer 141, a behavior analyzer 143 and a constraint engine 145. In addition, other analyzers may be used focusing on different approaches for determining accuracy. In some implementations, the prediction analysis engine 140 includes an AI model to perform the verification. For example, different AI models can be used to perform the functions of the game context analyzer 141, behavior analyzer 143, and constraint engine 145. As such, the prediction analysis engine 140 may determine that the predicted gesture 450A is correct or incorrect, and feed that indication as training data 470 back into the AI model for purposes of updating the AI model. For example, when the feedback indicates that the predicted gesture 450a is incorrect, then the solution set of predefined gestures used for prediction can be reduced, such that the next iterative implementation of the AI model 170 to predict the performed gesture 345 (or any similar performed gesture) will be more accurate. In that manner, the AI model 170 that is updated outputs an updated predicted gesture 450B, for the same performed gesture, which is sent to the action engine 370. Another feedback loop may be performed to verify the updated predicted gesture 450B in a subsequent iteration.

A determination that the predicted gesture 450A is correct or incorrect by the prediction analysis engine 140 may be directly determined or indirectly inferred, or a combination of both for relational purposes. For example, during initial stages of training the AI model 170, a more direct approach may be taken by each of the components of the prediction analysis engine 140 (e.g., engines 141, 143, 145, etc.). That is, the communicator may be directly queried whether or not the predicted gesture 450A is correct. The response from the communicator is then fed back to the AI model 170 for training and updating.

The direct approach may be combined with an indirect approach for relational purposes, such that the indirect approach may be used later to infer whether the predicted gesture 450A is correct or not. For instance, the indirect approach may be to query the communicator to perform one of a selection of tasks, or whether or not to perform a single task. Selection of certain tasks (e.g., side quests, questions, etc.) or whether or not to perform a single task may indicate (as confirmed with results from the direct approach) that the predicted gesture 450A is incorrect. For example, if the communicator is frustrated after the action is performed, responsive to the predicted gesture 450A, then the communicator probably does not want to perform the single task (e.g., thinks it is a waste of time) or may select a task from a group of tasks that reflects that frustration (e.g., the easiest task, or a task that releases the frustration, etc.). The communicator's response in the indirect approach can be confirmed with the response to the direct approach (e.g., all indicate that the predicted gesture 450A is incorrect), and later the indirect approach may be used in isolation to determine whether a future predicted gesture (related or unrelated to predicted gesture 450A) is incorrect.

Specifically, while the direct approach is straightforward with minimal errors, eventually it may prove ineffective as the communicator may tire from repeated queries regarding accuracy of predicted gestures, such as when playing a video game that requires intense concentration. As such, as the AI model 170 matures through longer periods of training, a more indirect approach is used to infer whether the predicted gesture 450A is correct or incorrect. For example, inference of correctness may be determined by each of the analyzers (e.g., game context analyzer 141, behavior analyzer 143, and constraint engine 145).

In particular, the game context analyzer 141 is configured to determine a context within which the communicator is communicating. For example, within gaming, the game context may relate to a position within the game play when the communicator performs the gesture (e.g., that may be deformed). As such, once the context is determined, the game context analyzer 141 can determine if the predicted gesture 450A is consistent with or aligned with the context (e.g., is the predicted gesture aligned with the game context of the game play of the video game). For instance, when two users are communicating within a context, it can be determined if the predicted gesture corresponding to a predicted communication is consistent with the context. If the predicted gesture 450A is not consistent with the context, then the predicted gesture is incorrect.

The behavior analyzer 143 is configured to determine an emotion of the communicator. For example, the behavior analyzer may analyze one or more of biometric data of the communicator, motion data of the communicator, audio data of the communicator, controller motion, environmental data, etc. A particular emotion may be inferred based on the collected data. For example, the analysis may determine that the communicator is frustrated, which indicates that the predicted gesture is incorrect, based on an increase in heartrate, or an audible sound of frustration from the communicator, increased intensity and/or speed of making gestures, or when the communicator repeats the gesture over (and possibly multiple times with increased intensity and/or speed), etc.

The constraint engine 145 is configured to determine whether there are any physical or virtual constraints within a gesture space that are impeding the communicator from performing the performed gesture fully. The gesture space may be in a real environment or in a virtual environment (i.e., performed by an avatar within the virtual space). In another embodiment, the constraint engine 145 can be implemented in cooperation with the AI model 170 to initially classify and/or label, and/or identify, and/or predict the predicted gesture 450A. For example, the operations of the constraint engine 145 may be performed as a final filter function and/or condition to be satisfied upon the initial classification and/or prediction of the performed gesture. In another embodiment, the constraint engine 145 can be implemented when it is discovered that the predicted gesture 450A is incorrect. That is, a determination that the action performed by the action engine 370 has failed, and/or a determination that the predicted gesture is incorrect may trigger the constraint engine 145 to operate.

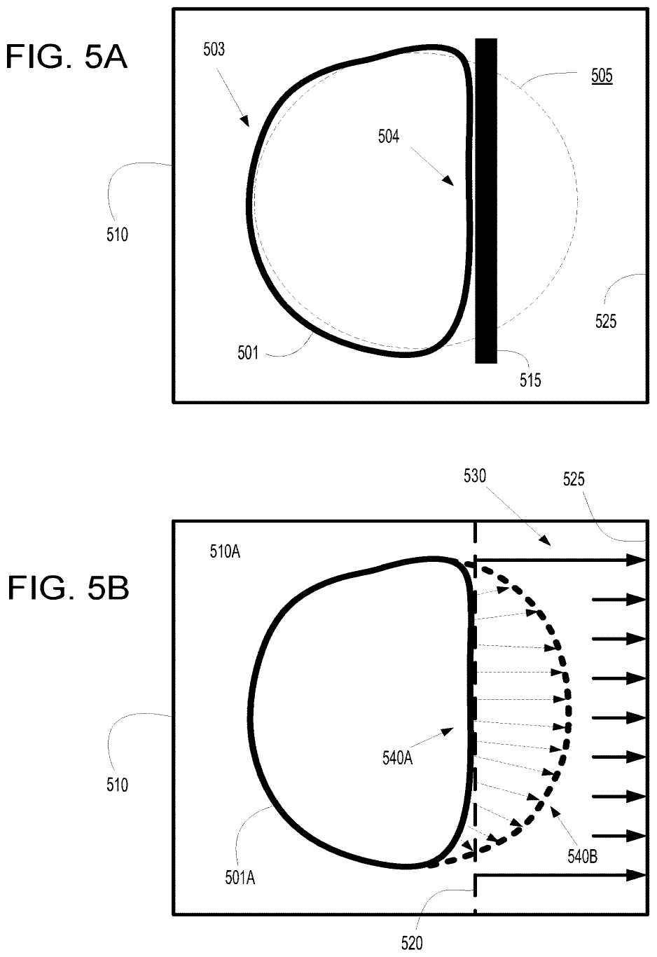

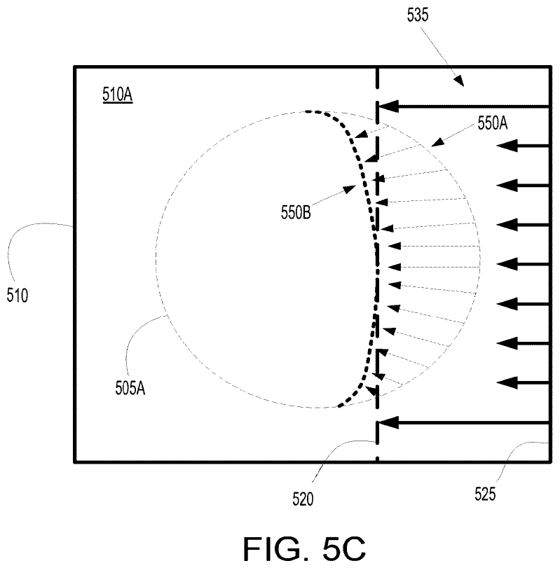

For example, if a constraint is discovered, then the constraint engine 145 is able to modify the performed gesture 345 and/or the gesture space and/or defined gestures that are known based on the constraint for purposes of classifying the performed gesture 345 as the predicted gesture 450A, initially, or as the predicted gesture 450A once the AI model 170 has been updated. In particular, the performed gesture 345 and/or the gesture space and/or defined gestures that are known that is modified based on the constraint is fed back to the AI model 170 as training data 470 for purposes of training and updating the AI model 170. In some embodiments, the constraint is fed back to the AI model, which is configured to modify the performed gesture 345 and/or the gesture space and/or defined gestures that are known. In that manner, the updated AI model 170 is configured to classify and/or label, and/or identify, and/or predict the predicted gesture 450B (i.e., updated predicted gesture). In some embodiments, the constraint engine 145 is able to match the performed gesture 345 and/or the gesture space and/or the defined gestures that are known that are modified to match the performed gesture 345 to the predicted gesture 450B. The modifications to the performed gesture 345 and/or the gesture space and/or defined gestures that are known are further described in FIGS. 5A-5C.

In particular, FIGS. 5A-5C illustrate a deformed gesture performed by a communicator, and/or the reshaping of a deformed gesture that is performed within a gesture space that is physically or virtually constrained by removing an effect of the corresponding constraint, and/or the reshaping of a gesture space defined for a fully performed gesture in consideration of the constraint, in accordance with embodiments of the present disclosure. for example, the processes shown in FIGS. 5A-5C for modifying the performed gesture 345 and/or the gesture space and/or defined gestures that are known can be implemented by the constraint engine 145 and/or the AI model 170.

For purposes of illustration, FIGS. 5A-5C are described within the context of a gesture performed within a space that is constrained. The communicator intends to perform a gesture in the shape of a circle, but because the space is constrained the communicator performs a deformed gesture in the shape of an ellipse. In the solve set of defined gestures that are known, a circle gesture and the ellipse gesture have different meanings.

FIG. 5A illustrates a gesture space 510 that includes a constraint 515. The gesture space 510 without the constraint allows for full movement of the communicator to perform a gesture in full. The gesture space 510 and any constraints within the gesture space may be determined by mapping a physical environment surrounding the communicator to determine boundaries of the gesture space 510, for example by using tools previously described, or by mapping a virtual environment surrounding an avatar corresponding to the communicator within a virtual space. In that manner, the gesture space 510 is defined, and a constraint 515 may be discovered that restricts the motion of the communicator or avatar corresponding to the communicator. In some cases, a constraint 515 that is virtual may not physically hinder the communicator from physically performing a gesture in full, but the communicator may perceive that the virtual constraint actually restricts his or her physical motion. Once the constraint 515 is discovered, and determined to change the gesture space 510 outside of some tolerance or threshold, the operations of the constraint engine 145 may be triggered to operate to determine if a performed gesture needs modification based on the constraint.

In particular, a performed gesture 501 of a communicator is shown. The communicator wished to convey an intended gesture 505 having a circular shape, wherein the intended gesture 505 corresponds with a defined gesture that is known. Because of the perceived or actual influence of constraint 515, the performed gesture 501 is deformed, and is in the form of an ellipse. Specifically, the performed gesture 501 has a left side 503 that is mostly true to its circular intent, but a right side 504 that is deformed (e.g., flattened) due to the influence of the constraint 515. As shown, the right side 504 of the performed gesture 501 is closer to the right side 525 of the gesture space 510.

FIG. 5B illustrates the reshaping of a gesture space 510A that is constrained based on the constraint 515, in accordance with one embodiment of the present disclosure. As shown, the gesture space 510A that is constrained is defined based on the constraint 515, and is bounded by the gesture space 510 that allows for fully performing the intended gesture 505 (i.e., without constraint). The gesture space 510A has a right side 520, corresponding with the constraint 515, that is pulled to the right (as shown by the arrows 530) until reaching side 525 of the gesture space 510 that allows for fully performing the gesture. That is, the gesture space 510A that is constrained is reshaped to closely match the gesture space 510 that allows for fully performing the gesture (i.e., the right side 520 is aligned with right side 525).

As the gesture space 510A that is constrained is reshaped, correspondingly the performed gesture that is deformed is also reshaped. The performed gesture 501 that is deformed is shown now as performed gesture 501A that is deformed and reshaped. In particular, performed gesture 501A has a right side 540A that initially is deformed (i.e., aligned with right side 504 of performed gesture 501), but that is reshaped by moving to the right (as indicated by arrows) to a right side 540B (see the dotted arc). As such, the performed gesture 501 that is deformed is now reshaped (see gesture 501A) based on the gesture space that is initially constrained but now also reshaped. Further, in one embodiment the deformed gesture that is reshaped matches a defined gesture that is known for classification by the AI model. As such, the constraint engine may be used to modify the performed gesture that is deformed as if it were performed within an unconstrained space, wherein the modified performed gesture (i.e., the performed gesture that is deformed and reshaped) can be used for matching using a solve set of gestures (i.e., known and defined within an unconstrained gesture space).

FIG. 5C illustrates the reshaping of a gesture space 510, that allows for fully performing the intended gesture 505, based on the constraint, in accordance with one embodiment of the present disclosure. The gesture space 510 has a right side 525 that is pulled to the left (as shown by arrows 535) until reaching side 520 of the gesture space 510A that is constrained. That is, the gesture space 510, that allows for fully performing the intended gesture 505, is reshaped to closely match the gesture space 510A that is constrained (i.e., the right side 525 is aligned with the right side 520). For example, the gesture space 510 that is unconstrained can be manipulated and/or reshaped to fit within the constrained space.

As the gesture space 510, that allows for fully performing the intended gesture 505, is reshaped, correspondingly each of a solve set of gestures (i.e., known and defined within an unconstrained gesture space) is also reshaped. For example, a defined gesture 505A, that closely aligns with intended gesture 505, is reshaped. In particular, the defined gesture 505A has a right side 550A that is not deformed, and is reshaped by moving to the left (as indicated by arrows) to a right side 550B (see the dotted arc). As such, the defined gesture 505A that is now reshaped based on the constraint and/or based on the gesture space 510 that is reshaped to align with the gesture space 510A that is constrained. Further, the constraint engine may be used to modify and/or distort and/or reshape each of the solve set of gestures based on the gesture space 510 that is reshaped, wherein the solve set of gestures that have been modified can be used for matching to the performed gesture 501 that is deformed.

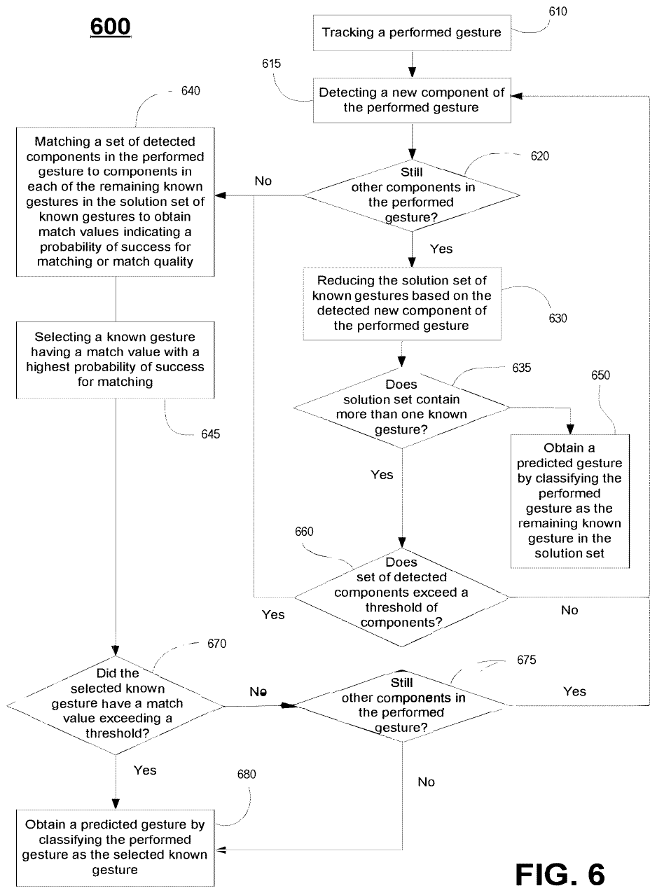

FIG. 6 is a flow diagram 600 illustrating a method for early prediction of a gesture, performed by a communicator, in accordance with one embodiment of the present disclosure. In that manner, a predicted gesture can be classified and/or identified before the gesture has been fully performed by the communicator. Also, an action can be identified and/or performed earlier, based on the predicted gesture that is also identified earlier, and in some cases even before the gesture has been fully completed. The operations performed in the flow diagram 600 may be implemented by one or more of the previously described components in system 100 of FIG. 1, or system 300 of FIG. 3, including the gesture prediction engine 120.

In particular, at 610, a performed gesture is tracked throughout its performance. Components of the performed gesture can be identified and/or defined. At 615, a new component of the performed gesture is detected and added to a set of detected components for the performed gesture. This new component can be a first component, a middle component, or an ending component. At decision step 620, it is determined whether there are other components to be identified in the performed gesture. For example, if the gesture continues to be tracked, then other components remain. If there are no other components, the method proceeds to 640, otherwise the method proceeds to 630.

At 640, if the new component of the performed gesture is also the last component to be performed, then the set of detected components for the performed gesture is matched to corresponding components in each of a solution or solve set of known gestures, and more particularly matched to corresponding components of remaining known gestures in the solution set. The solution set of known gestures may include defined gestures that are known. Match values are obtained indicating a probability of success or match quality for matching the performed gesture to one of the remaining known gestures, and more particularly matching the set of detected components of the performed gesture to components of the remaining known gestures. At 645 a known gesture is selected that has a match value with a highest probability of success, such that the performed gesture is matched to the selected, known gesture.

At decision step 670, it is determined whether the match value for the known gesture that is selected exceeds a threshold. If the match value exceeds the threshold, then the known gesture that is selected is a predicted gesture, wherein the performed gesture is classified and/or identified and/or predicted as the known gesture that is selected at 680, such as by using an AI model. On the other hand, if the match value does not exceed the threshold, then the method proceeds to decision step 675, where it is determined whether there are other components to be identified in the performed gesture. If there are no other components, then the method proceeds to step 680, such that the performed gesture is classified and/or identified and/or predicted as the known gesture that is selected. On the other hand, if there are still other components, then the method proceeds back to step 615.

Returning back to decision step 620, if it is determined that there remains other components in the performed gesture to be identified, then the method proceeds to step 630 where the solution set of known gestures is reduced based on the detected new component of the performed gesture. That is, only known gestures having at least one component that is aligned with the new component remain within the solution set of known gestures, and those gestures that do not have at least one component aligned with the new component are removed.

After reducing the solution set of known gestures, the method proceeds to decision step 635 to determine whether there are multiple known gestures in the solution set of known gestures. If there is only one known gesture in the solution set, then at 650 the performed gesture is classified and/or identified and/or predicted as the remaining known gesture in the solution set. On the other hand, if there is more than one known gesture in the solution set, then the method proceeds to decision step 660 to determine whether the set of detected components exceed a threshold number of components. For example, this condition provides for performing early prediction of a gesture with some confidence that a result has some degree of accuracy. In particular, if the set of detected components exceeds the threshold number of components, then there is confidence that the number of detected components can be matched to components of a corresponding known gesture in the solution set, and that the match exceeds a degree of accuracy. In that manner, the method proceeds to step 640. On the other hand, if the set of detected components does not exceed the threshold number of components, then the method proceeds back to step 615 to detect the next new component.

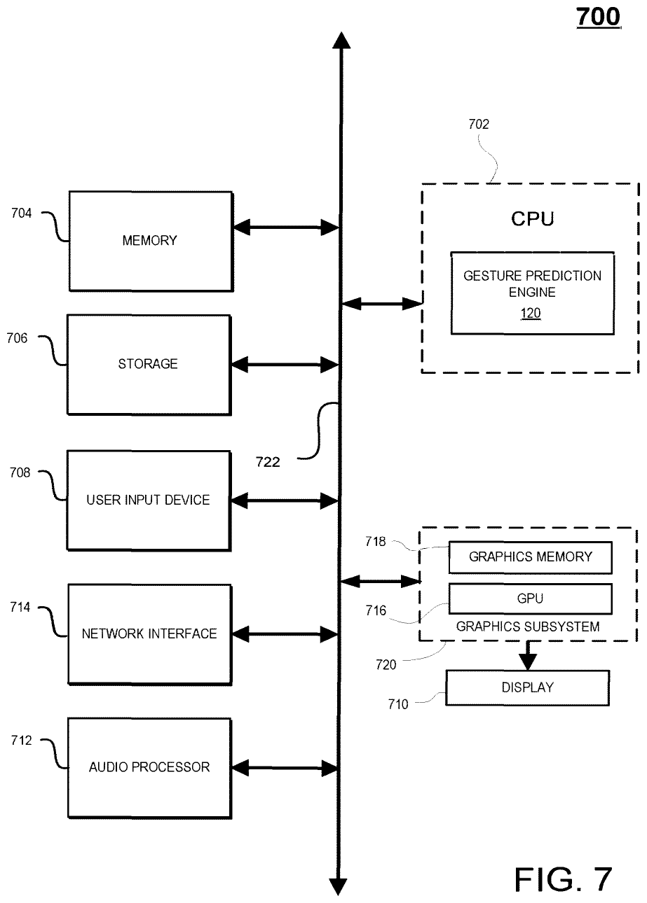

FIG. 7 illustrates components of an example device 700 that can be used to perform aspects of the various embodiments of the present disclosure. This block diagram illustrates a device 700 that can incorporate or can be a personal computer, video game console, personal digital assistant, a server or other digital device, and includes a central processing unit (CPU) 702 for running software applications and optionally an operating system. CPU 702 may be comprised of one or more homogeneous or heterogeneous processing cores. Further embodiments can be implemented using one or more CPUs with microprocessor architectures specifically adapted for highly parallel and computationally intensive applications.

In particular, CPU 702 may be configured to implement a gesture prediction engine 120 that is configured to identify gestures that may be occluded or deformed using an AI model, wherein dynamic updating of the AI model is performed with feedback when the prediction of the gesture is incorrect. In that manner, the AI model is adaptable to the movements of the communicator and/or to the environment (e.g., real or virtual) within which the gesture is performed, such that ultimately the gesture is predicted correctly.

Memory 704 stores applications and data for use by the CPU 702. Storage 706 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 708 communicate user inputs from one or more users to device 700, examples of which may include keyboards, mice, joysticks, touch pads, touch screens, still or video recorders/cameras, tracking devices for recognizing gestures, and/or microphones. Network interface 714 allows device 700 to communicate with other computer systems via an electronic communications network, and may include wired or wireless communication over local area networks and wide area networks such as the internet. An audio processor 712 is adapted to generate analog or digital audio output from instructions and/or data provided by the CPU 702, memory 704, and/or storage 706. The components of device 700 are connected via one or more data buses 722.

A graphics subsystem 720 is further connected with data bus 722 and the components of the device 700. The graphics subsystem 720 includes a graphics processing unit (GPU) 716 and graphics memory 718. Graphics memory 718 includes a display memory (e.g., a frame buffer) used for storing pixel data for each pixel of an output image. Pixel data can be provided to graphics memory 718 directly from the CPU 702. Alternatively, CPU 702 provides the GPU 716 with data and/or instructions defining the desired output images, from which the GPU 716 generates the pixel data of one or more output images. The data and/or instructions defining the desired output images can be stored in memory 704 and/or graphics memory 718. In an embodiment, the GPU 716 includes 3D rendering capabilities for generating pixel data for output images from instructions and data defining the geometry, lighting, shading, texturing, motion, and/or camera parameters for a scene. The GPU 716 can further include one or more programmable execution units capable of executing shader programs. In one embodiment, GPU 716 may be implemented within an AI engine (e.g., machine learning engine 190) to provide additional processing power, such as for the AI, machine learning functionality, or deep learning functionality, etc.

The graphics subsystem 720 periodically outputs pixel data for an image from graphics memory 718 to be displayed on display device 710. Display device 710 can be any device capable of displaying visual information in response to a signal from the device 700.

In other embodiments, the graphics subsystem 720 includes multiple GPU devices, which are combined to perform graphics processing for a single application that is executing on a CPU. For example, the multiple GPUs can perform alternate forms of frame rendering, including different GPUs rendering different frames and at different times, different GPUs performing different shader operations, having a master GPU perform main rendering and compositing of outputs from slave GPUs performing selected shader functions (e.g., smoke, river, etc.), different GPUs rendering different objects or parts of scene, etc. In the above embodiments and implementations, these operations could be performed in the same frame period (simultaneously in parallel), or in different frame periods (sequentially in parallel).

Accordingly, in various embodiments the present disclosure describes systems and methods configured for identifying gestures that may be occluded or deformed by a communicator using an AI model, and the dynamic updating of the AI model with feedback when the prediction of the gesture is incorrect.

It should be noted, that access services, such as providing access to games of the current embodiments, delivered over a wide geographical area often use cloud computing. Cloud computing is a style of computing in which dynamically scalable and often virtualized resources are provided as a service over the Internet. For example, cloud computing services often provide common applications (e.g., video games) online that are accessed from a web browser, while the software and data are stored on the servers in the cloud.

A game server may be used to perform operations for video game players playing video games over the internet, in some embodiments. In a multiplayer gaming session, a dedicated server application collects data from players and distributes it to other players. The video game may be executed by a distributed game engine including a plurality of processing entities (PEs) acting as nodes, such that each PE executes a functional segment of a given game engine that the video game runs on. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. The PEs may be virtualized by a hypervisor of a particular server, or the PEs may reside on different server units of a data center. Respective processing entities for performing the operations may be a server unit, a virtual machine, or a container, GPU, CPU, depending on the needs of each game engine segment. By distributing the game engine, the game engine is provided with elastic computing properties that are not bound by the capabilities of a physical server unit. Instead, the game engine, when needed, is provisioned with more or fewer compute nodes to meet the demands of the video game.

Users access the remote services with client devices (e.g., PC, mobile phone, etc.), which include at least a CPU, a display and I/O, and are capable of communicating with the game server. It should be appreciated that a given video game may be developed for a specific platform and an associated controller device. However, when such a game is made available via a game cloud system, the user may be accessing the video game with a different controller device, such as when a user accesses a game designed for a gaming console from a personal computer utilizing a keyboard and mouse. In such a scenario, an input parameter configuration defines a mapping from inputs which can be generated by the user's available controller device to inputs which are acceptable for the execution of the video game.

In another example, a user may access the cloud gaming system via a tablet computing device, a touchscreen smartphone, or other touchscreen driven device, where the client device and the controller device are integrated together, with inputs being provided by way of detected touchscreen inputs/gestures. For such a device, the input parameter configuration may define particular touchscreen inputs corresponding to game inputs for the video game (e.g., buttons, directional pad, gestures or swipes, touch motions, etc.).

In some embodiments, the client device serves as a connection point for a controller device. That is, the controller device communicates via a wireless or wired connection with the client device to transmit inputs from the controller device to the client device. The client device may in turn process these inputs and then transmit input data to the cloud game server via a network. For example, these inputs might include captured video or audio from the game environment that may be processed by the client device before sending to the cloud game server. Additionally, inputs from motion detection hardware of the controller might be processed by the client device in conjunction with captured video to detect the position and motion of the controller before sending to the cloud gaming server.

In other embodiments, the controller can itself be a networked device, with the ability to communicate inputs directly via the network to the cloud game server, without being required to communicate such inputs through the client device first, such that input latency can be reduced. For example, inputs whose detection does not depend on any additional hardware or processing apart from the controller itself can be sent directly from the controller to the cloud game server. Such inputs may include button inputs, joystick inputs, embedded motion detection inputs (e.g., accelerometer, magnetometer, gyroscope), etc.

Access to the cloud gaming network by the client device may be achieved through a network implementing one or more communication technologies. In some embodiments, the network may include 5th Generation (5G) wireless network technology including cellular networks serving small geographical cells. Analog signals representing sounds and images are digitized in the client device and transmitted as a stream of bits. 5G wireless devices in a cell communicate by radio waves with a local antenna array and low power automated transceiver. The local antennas are connected with a telephone network and the Internet by high bandwidth optical fiber or wireless backhaul connection. A mobile device crossing between cells is automatically transferred to the new cell. 5G networks are just one communication network, and embodiments of the disclosure may utilize earlier generation communication networks, as well as later generation wired or wireless technologies that come after 5G.

In one embodiment, the various technical examples can be implemented using a virtual environment via a head-mounted display (HMD), which may also be referred to as a virtual reality (VR) headset. As used herein, the term generally refers to user interaction with a virtual space/environment that involves viewing the virtual space through an HMD in a manner that is responsive in real-time to the movements of the HMD (as controlled by the user) to provide the sensation to the user of being in the virtual space or metaverse. An HMD can be worn in a manner similar to glasses, goggles, or a helmet, and is configured to display a video game or other metaverse content to the user. The HMD can provide a very immersive experience in a virtual environment with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures (e.g., commands, communications, pointing and walking toward a particular content item in the scene, etc.). In one embodiment, the gestures can be tracked and processed by the system to generate a prediction of interaction with the particular content item in the game scene. In some embodiments, machine learning may be used to facilitate or assist in the prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network, such as internet, cellular, etc. In one embodiment, the cloud computing and gaming system maintains and executes the video game being played by the user. In some embodiments, the cloud computing and gaming system is configured to receive inputs from the HMD and/or interfacing objectsover the network. The cloud computing and gaming system is configured to process the inputs to affect the game state of the executing video game. The output from the executing video game, such as video data, audio data, and haptic feedback data, is transmitted to the HMD and the interface objects.

Additionally, though implementations in the present disclosure may be described with reference to n HMD, it will be appreciated that in other implementations, non-HMDs may be substituted, such as, portable device screens (e.g., tablet, smartphone, laptop, etc.) or any other type of display that can be configured to render video and/or provide for display of an interactive scene or virtual environment. It should be understood that the various embodiments defined herein may be combined or assembled into specific implementations using the various features disclosed herein. Thus, the examples provided are just some possible examples, without limitation to the various implementations that are possible by combining the various elements to define many more implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

With the above embodiments in mind, it should be understood that embodiments of the present disclosure can employ various computer-implemented operations involving data stored in computer systems. These operations are those requiring physical manipulation of physical quantities. Any of the operations described herein in embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server, or by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator that emulates a processing system.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A computer-implemented method, comprising:
maintaining data representing a plurality of defined gestures;
detecting a gesture performed by a communicator in a gesture space;
identifying a constraint of the gesture space;
modifying the gesture performed by the communicator based on the identified constraint of the gesture space to determine a modified gesture;
providing the modified gesture as input to an artificial intelligence (AI) model that is configured to output classifications of gestures;
obtaining, as output from the AI model, a classification of the modified gesture as one of the plurality of defined gestures; and
performing an action based on the classification of the modified gesture.

2. The method of claim 1, wherein detecting the gesture includes:
tracking movement of a part of the communicator or movement of a hand-held controller.

3. The method of claim 1, wherein the constraint of the gesture space comprises a real-world object in the gesture space.

4. The method of claim 1, wherein the constraint of the gesture space comprises a virtual object in the gesture space.

5. The method of claim 4, wherein the gesture space is part of a virtual environment surrounding an avatar corresponding to the communicator, and identifying the constraint comprises mapping objects within the virtual environment.

6. The method of claim 1, wherein the constraint comprises an object that occludes at least part of the gesture performed by the communicator.

7. The method of claim 1, wherein modifying the gesture is responsive to determining that the gesture performed by the communicator does not match any of the plurality of defined gestures within a threshold match value.

8. The method of claim 1, wherein the gesture performed by the communicator has a first shape, and modifying the gesture comprises reshaping the gesture performed by the communicator from the first shape to a second shape based on the identified constraint.

9. The method of claim 8, wherein the second shape represents a shape of a gesture that would likely have been performed by the communicator with the constraint removed from the gesture space.

10. The method of claim 1, wherein the action comprises executing a command in a video game.

11. A non-transitory computer-readable medium storing instructions which, when executed, cause at least one processing device to perform operations comprising:
maintaining data representing a plurality of defined gestures;
detecting a gesture performed by a communicator in a gesture space;
identifying a constraint of the gesture space;
modifying the gesture performed by the communicator based on the identified constraint of the gesture space to determine a modified gesture;
providing the modified gesture as input to an artificial intelligence (AI) model that is configured to output classifications of gestures;
obtaining, as output from the AI model, a classification of the modified gesture as one of the plurality of defined gestures; and
performing an action based on the classification of the modified gesture.

12. The non-transitory computer-readable medium of claim 11, wherein detecting the gesture includes:
tracking movement of a part of the communicator or movement of a hand-held controller.

13. The non-transitory computer-readable medium of claim 11, wherein the constraint of the gesture space comprises a real-world object in the gesture space.

14. The non-transitory computer-readable medium of claim 11, wherein the constraint of the gesture space comprises a virtual object in the gesture space.

15. The non-transitory computer-readable medium of claim 14, wherein the gesture space is part of a virtual environment surrounding an avatar corresponding to the communicator, and identifying the constraint comprises mapping virtual objects within the virtual environment.

16. The non-transitory computer-readable medium of claim 11, wherein the constraint comprises an object that occludes at least part of the gesture performed by the communicator.

17. The non-transitory computer-readable medium of claim 11, wherein modifying the gesture is responsive to determining that the gesture performed by the communicator does not match any of the plurality of defined gestures within a threshold match value.

18. The non-transitory computer-readable medium of claim 11, wherein the gesture performed by the communicator has a first shape, and modifying the gesture comprises reshaping the gesture performed by the communicator from the first shape to a second shape based on the identified constraint.

19. The non-transitory computer-readable medium of claim 18, wherein the second shape represents a shape of a gesture that would likely have been performed by the communicator with the constraint removed from the gesture space.

20. The non-transitory computer-readable medium of claim 11, wherein the action comprises executing a command in a video game.
